(19) United States
(12) Patent Application Publication
(10) Pub. No.: US 2002/0129693 A1
(43) Pub. Date: Sep. 19, 2002

(54) Interactive audio distribution system

(76) Inventor: Brad Wilks, Athens, GA (US)

Correspondence Address: ADAMS & WILKS, 31st Floor, 50 Broadway, New York, NY, 10004, US

(21) Appl. No.: 09/810,633

(22) Filed: Mar. 16, 2001

(51) Int. Cl. G10H 1/26

(52) U.S. Cl. 84/609

(57) ABSTRACT

A method and apparatus for receiving, storing and playing music, the apparatus comprising a server for storing a plurality of songs, and being capable of communicating with one or more interactive multimedia systems for receiving from the interactive multimedia systems a list of selected songs and transmitting the requested songs to the interactive multimedia systems, and a processor for maintaining records of songs downloaded to the interactive multimedia systems, the interactive multimedia systems comprising stereo equipment for playing selected ones of the songs in a user-defined sequence and schedule, and a processor for controlling the stereo equipment to play the selected songs in the desired sequence and schedule and controlling the selection and downloading of songs from the server, and the method comprising the steps of creating a play list of songs, transmitting from the server to the interactive multimedia system a list of one or more selected songs, receiving and playing the received songs in a pre-defined sequence and schedule, and updating the play list to add or remove songs.

### BACKGROUND OF THE INVENTION

1. Field of the Invention

The present invention relates generally to improvements in interactive multimedia entertainment systems and, in particular, to a system and method for the selection, transmission and playing of audio information such as music in accordance with a pre-selected sequence and schedule.

2. Description of the Related Art

Music is an essential part of the hospitality industry. Restaurants and clubs are often visited by patrons seeking a particular atmosphere as well as food and drink. In many instances, background music is equally as important a factor as physical layout and decor in the creation of a particular atmosphere.

Conventional broadcast radio is not generally used in restaurants and bars to provide background music because the music is accompanied with talk and commercial content, and the sequence and schedule of songs cannot be selectively varied by the listener.

Moreover, while members of the general public are authorized to freely play and record publicly broadcast music, a similar authorization does not extend to the hospitality industry and to businesses in general. Restaurateurs, club owners and businesses at large are specifically excluded from the license granted to the general public to play and record music subject to copyright protection. In order to play such music, business owners are required to obtain a compulsory license from one or more of the established licensing entities such as ASCAP or BMI.

The compulsory license requirement has given rise to a segment of the music distribution industry engaged primarily in the licensing and distribution of copyrighted music to businesses such as restaurants and bars for play during business hours. Various distribution and monitoring methods are used to provide and monitor the playing of protected music, many of which involve the use of proprietary equipment. In order to reduce licensing fees, various entities are engaged in the distribution of public domain music to businesses, or in distributing renditions of popular songs re-recorded by unknown musicians. For example, the Muzak Corporation offers a wide list of popular songs of various types for distribution to businesses. Businesses interested in obtaining background music at a reduced royalty rate are provided with renditions of well-known musical pieces rather than the original popular performance of those pieces.

Conventionally, music distribution has involved the selection by a business owner of a musical type or a play list of songs which are provided to the business owner in the form of a magnetic or optical recording for playback on proprietary stereo or PA equipment licensed or sold by the music distribution company to the business operator. Although music distributed in this manner is often suitable for its intended purpose, it does not offer the flexibility and selectability that is often desired in various types of businesses, such as restaurants and bars. Music may be limited to a particular type, or selections may be limited solely to song titles included in pre-selected play lists without providing the business owner with the ability to easily add additional song titles and delete others. Moreover, the sequence and schedule of playback cannot be varied easily and normally requires familiarity with the operating procedures of special equipment.

Due to the limitations of conventional music distribution methods and systems, many owners of bars, restaurants, hotels, and the like often purchase their own music on pre-recorded CDs or other media for play during business hours. While this offers the desired flexibility, it presents various drawbacks. The recording medium, such as CD or laser disk, requires a purchaser to buy one disk that contains a dozen or so songs although only one or two may be of interest, thus increasing the effective cost of the entertainment. It is also difficult to control the playing of songs including the sequence, selection and schedule of songs using conventional CDs and CD players.

There is thus a need for a method and system that permits a business operator to select songs to be stored and played in a desired sequence and schedule from an interactive song library containing songs from a variety of music types and artists to enable a level of customized selection and playing that cannot be duplicated by a broadcast format or by the use of conventional equipment. Providing the user access to an interactive song library of this type permits the downloading and playing of a wide variety of music while avoiding the expense associated with the purchase of prerecorded music and the need for users to listen to commercials or to unsuitable or undesirable content.

### SUMMARY OF THE INVENTION

In view of the foregoing drawbacks, it is an object of the present invention to provide a method and system for the selection, transmission and playing of songs in accordance with a pre-selected sequence and schedule.

Another object of the present invention is to provide a method and system for the selection, transmission and playing of songs in a desired sequence and schedule from an interactive song library containing songs from a variety of music types and artists to enable customized selection and playing.

Yet another object of the present invention is to provide a system of the foregoing type which is capable of operation over a computer network such as the Internet.

In order to achieve the foregoing objects and others which will become more apparent from a reading of the disclosure herein, the present invention provides an apparatus and method for receiving, storing and playing music, the apparatus comprising a server for storing a plurality of songs and having communication means for communicating with an interactive multimedia system for receiving from the interactive multimedia system a list containing one or more selected songs and transmitting the requested songs to the interactive multimedia system, and processing means for maintaining records of songs downloaded to the interactive multimedia system, the interactive multimedia system comprising playing means for playing selected ones of the songs in a user-defined sequence and schedule, processing means for maintaining records of songs played, and communication means for communicating with the server to send song requests and records to the server and to receive songs from the server, and the method comprising the steps of creating a play list of songs, transmitting from the server to the interactive multimedia system selected songs, receiving, storing and playing the received songs in a pre-defined sequence and schedule, and updating the play list to add or remove songs.

The server is preferably an Internet server and the interactive multimedia system is preferably a client computer connected to the Internet and to a stereo or PA system. A plurality of songs are stored in a compressed digital manner in the server along with a database allowing songs to be searched by title, music type, artist name, and the like.

The interactive multimedia system is preferably operated by a menu-driven user interface which allows a user to search for and select songs to be downloaded from the server and stored on the interactive multimedia system for playback based on the database search criteria.

The menu-driven system preferably has at least a first menu that allows a user to perform an interactive search through a database of songs stored in the server by categorizing the songs according to criteria such as song title, artist name, music type, musical era, and other descriptive criteria such as mood, tone and beat, and a second menu that allows the user to view a list of songs stored on the interactive multimedia system and to add or remove stored songs and control the sequence and schedule for playing the songs.

### BRIEF DESCRIPTION OF THE DRAWINGS

FIG. 1 is a block diagram showing a system for the distribution of songs in accordance with a preferred embodiment of the present invention;

FIG. 2 illustrates a menu that may be displayed on an interactive multimedia system in accordance with the preferred embodiment;

FIG. 3 illustrates another menu that may be displayed on an interactive multimedia system in accordance with the preferred embodiment;

FIG. 4 illustrates another menu that may be displayed on an interactive multimedia system in accordance with the preferred embodiment;

FIG. 5 illustrates a menu that may be displayed on an interactive multimedia system in accordance with the preferred embodiment; and

FIG. 6 is a flowchart of a method of selecting, transmitting and playing songs in accordance with a preferred embodiment of the present invention.

### DETAILED DESCRIPTION OF THE PREFERRED EMBODIMENTS

The present invention relates to an improvement in interactive multimedia entertainment systems. The following description is presented to enable one of ordinary skill in the art to make and use the invention and is provided in the context of a patent application and its requirements. Various modifications to the preferred embodiment will be readily apparent to those skilled in the art and the generic principles and features described herein.

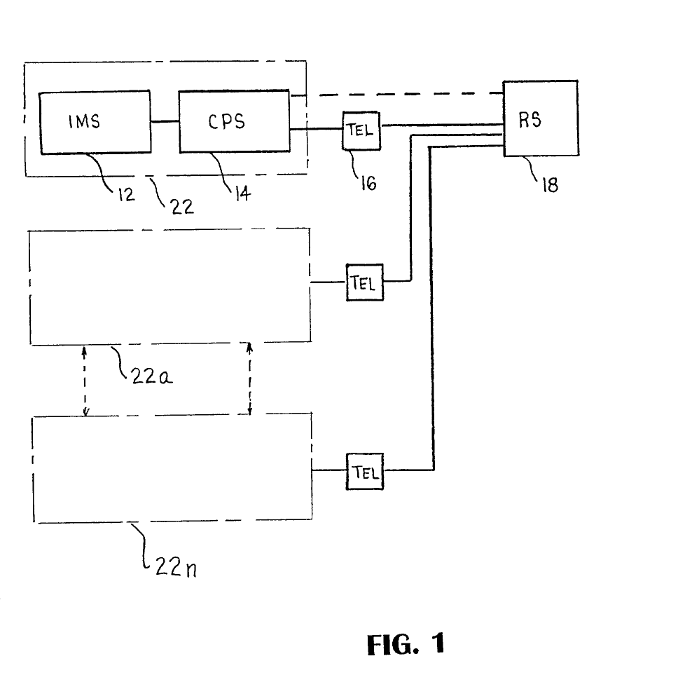

Referring to FIG. 1, what is shown is an interactive music entertainment system intended for use in the hospitality industry. As will be understood, while the system 10 is described in connection with the hospitality industry, it may be used in any business or in a private home. The interactive music entertainment system 10 comprises an interactive multimedia system (IMS) 12 which receives program source material such as songs or records of CD quality through a call processing system (CPS) 14 which, in turn, may be connected through a conventional telephone 16 to a remote multimedia server (RS) 18.

The remote multimedia server (RS) 18 is capable of providing for the storage of certain songs which could be played on a stereo system or the like. In this type of system, the remote multimedia server (RS) 18 could provide a CD quality song which can be transmitted over a network through the telephone 16. As illustrated by a dashed line in FIG. 1, the connection between the interactive multimedia system (IMS) 12 and the remote server (RS) 18 may be achieved by means other than the telephone 16, such as by a direct network connection 20 or by a wireless connection.

The remote multimedia server (RS) 18 is used to digitally store a large number of songs that may be categorized and indexed by music type, artist, and the like, each of the songs being individually selectable by means of a user interface.

The remote multimedia server (RS) 18 preferably comprises a conventional computer system having adequate storage space and processing power to store a large number of songs, such as, for example, a personal computer. The songs may be obtained from any known source, including broadcast, cable, satellite, CDs, MP3 files, and the like. The songs are preferably stored in a conventional compressed digital format such as MP3. This enables the songs to be stored in memory on the remote server (RS) 18 as data files and allows the server 18 to transmit selected songs over the network as digital data. For example, the server 18 would be provided with a random access memory that may comprise any nonvolatile memory storage device principally utilized to randomly read/write and store significant quantities of information. In the known MP3 compression format, a song averages approximately 2-3 Megabytes. Thus, a single-sided, double-layered DVD could store approximately 3,000 songs. Even with higher audio quality requirements, forthcoming optical technology will provide disks with the potential to store even larger audio libraries. Thus, a small number of laser-readable disk could potentially store an entire audio library. Similarly, hard disk drives with as much as 30 GB are now available at mass market price points. In this manner, an entire audio library could potentially be stored on a relatively small number of hard disk drives accommodated in the server 18 to achieve greater access speed than available using conventional laser-readable disks.

The remote multimedia server (RS) 18 is capable of communicating over a network via the telephone 16 to the interactive multimedia system (IMS) 12 to transmit selected songs to the interactive multimedia system (IMS) 12.

The call processing system (CPS) 14 can take credit or order information and can request for the transfer of one or more selected songs or other data files over the network or can request for a CD or like storage device containing the selected songs be delivered or shipped in the mail.

The remote server (RS) 18 has processing means for maintaining records of songs stored and played. In the presently described embodiment, the remote multimedia server 18 preferably limits the number of times or the length of time each song can be played by encoding the song in a particular way when it is sent to the interactive multimedia system (IMS) 12 and also can provide for a charge for each time a particular song is played by encoding the song to maintain a count in the interactive multimedia system (IMS) 12 and checking the count while the system 12 is connected to the remote server (RS) 12 or during a routine maintenance visit. Fees can also be based on the total number of songs downloaded and/or played, or the nature of the songs. As will be appreciated, the present invention allows detailed monitoring by the remote server (RS) 18 of songs selected and played by the interactive multimedia system (IMS) 12 so that fees may be charged based on the number of songs downloaded and played or any other monitored characteristic. Alternatively, one or both of the interactive multimedia system (IMS) 12 and the remote server (RS) 18 may verify that the user of the interactive multimedia system (IMS) 12 is currently authorized to play songs or to receive additional songs such as by determining whether an applicable license or equipment fee has been paid.

The call processing system (CPS) 14 may be as simple as a modem card or device in a conventional personal computer, or as sophisticated as may be required by a direct fiber optic access to a remote audio and communication service provider. Communications between the interactive multimedia system (IMS) 12 and the remote multimedia server (RS) 18 may alternatively be supported by means other than or in addition to a conventional telephone system, such as DSL, T1, T3, fiber optic cable, coaxial cable, twisted pair copper wire, or the cabling required to access a particular type of network. Communications between the interactive multimedia system (IMS) 12 and the remote server (RS) 18 may be achieved by means other than telephone, such as broadcast or pointcast audio and information delivery systems, or by the use of frequency multiplexing onto one or more communication channels that are typically used to carry other information, such as a broadcast, cable or satellite television channel.

In addition, the system may have the capability to make a personalized album. For example, if the recipient of a particular song wanted to record it directly from the interactive multimedia system (IMS) 12, he or she could send a signal to the interactive multimedia system (IMS) 12. The interactive multimedia system (IMS) 12 would then provide a high quality audio song to be recorded.

In order to achieve the desired functionality described herein, the interactive multimedia system (IMS) 12 and the call processing system (CPS) 14 are most preferably implemented using a conventional personal computer 22 with appropriate software designed to implement the methods described herein. The required software may instead be pre-loaded in the interactive multimedia system (IMS) 12 or may be transmitted from the remote multimedia server (RS) 18 over a network to the interactive multimedia system (IMS) 12 such as through the use of a direct network or Internet connection.

Conventional personal computers are typically provided with modems or similar communication devices which enable connectivity to remote computers over the Internet. This would enable the interactive multimedia system (IMS) 12 to establish a connection with the remote multimedia server (RS) 18 over the telephone 16 to enable the sending and receiving of information including the sending of a play list of available songs stored in the memory of the server 18 as well as the transmission of songs selected by a user of the interactive multimedia system (12). The selection of various songs by the user would be transmitted from the interactive multimedia system (IMS) 12 to the server 18. This is preferably achieved through the use of a menu-driven user interface in the form of an interactive song library which simplifies the selection of songs by indexing the songs according to music type, artist(s), and similar descriptive information.

As further illustrated in FIG. 1 by personal computers 22a-22n, a plurality of interactive multimedia systems may be connected to the remote multimedia server (RS) 18 by the means described above.

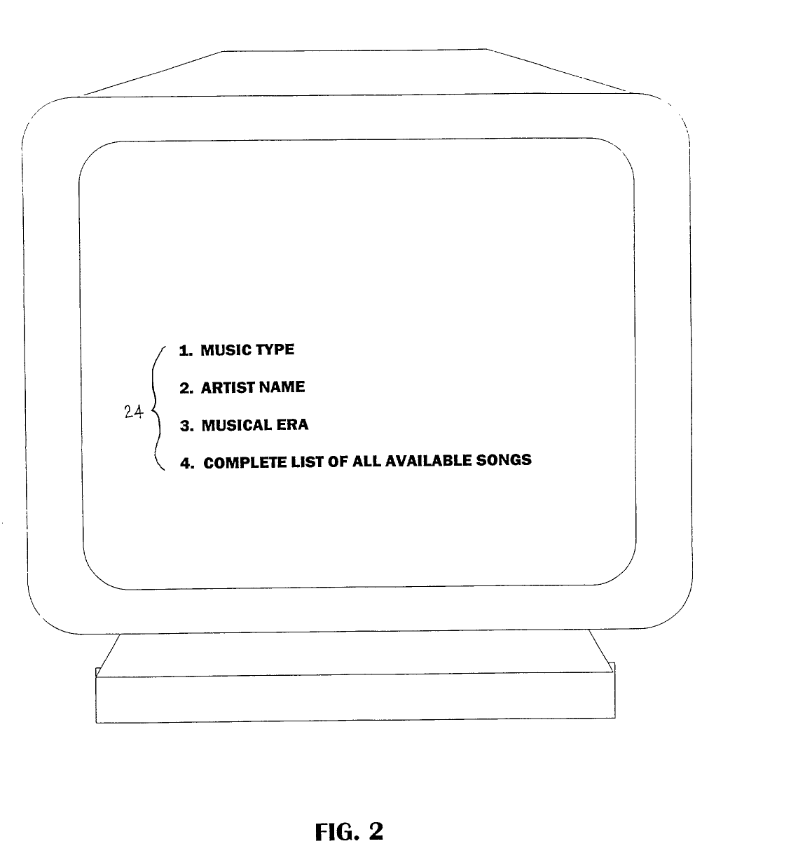

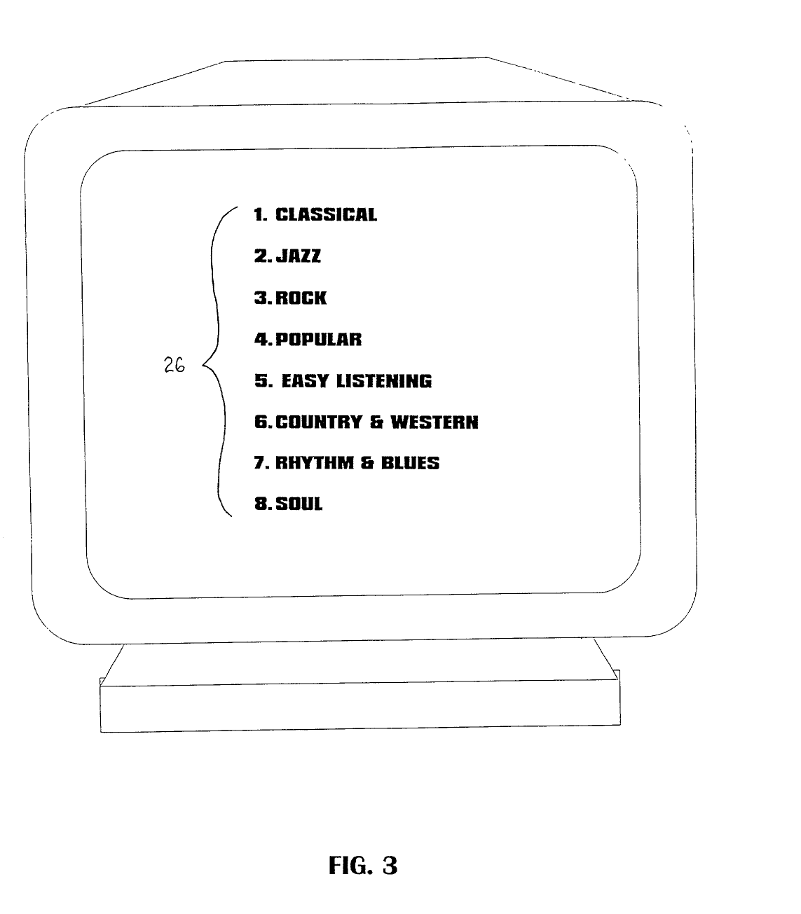

FIG. 2 is a simplified illustration of a menu 24 that may be displayed on the interactive multimedia system (IMS) 12 to facilitate the selection of songs according to the present invention. Another menu stored on the remote multimedia server (RS) 18 is transmitted to the interactive multimedia system (IMS) 12 based on the selection of one of a plurality of options, including “1. Music Type”, “2. Artist Name”, “3. Musical Era” and “4. Complete List of Available Songs” by a user of the interactive multimedia system (IMS) 12. Upon selection of one of one of the options from the menu 24, the remote multimedia server (RS) 18 responds by transmitting to the interactive multimedia system (IMS) 12 a menu containing further options. Thus, for example, if the user selects option “1. Music Type”, the remote multimedia server (RS) 18 transmits to the interactive multimedia system (IMS) 12 a file containing a menu 26 for displaying a list of music types, such as “1. Classical”, “2. Jazz”, “3. Rock”, “4. Popular”, 5. “Easy Listening”, “6. Country and Western”, “7. Rhythm and Blues”, “8. Soul”, and the like, corresponding to the categories of songs stored in the memory of the server 18. Such a menu 26 is illustrated in FIG. 3. As will be appreciated, the number and type of options are not limited to the foregoing.

Similarly, if the user selects option “2. Artist Name” from the menu 24, the remote multimedia server (RS) 18 transmits to the interactive multimedia system (IMS) 12 a file containing a menu for displaying further a list of artist names corresponding to songs stored in the server's memory 18. Selection of option “3. Musical Era” provides the user with a menu containing a list of selectable time periods to create a desired atmosphere through the use of period music. Other options, such as mood, tone, tempo and beat may be provided to facilitate the setting of particular atmosphere. Thus, for instance, a romance mood would be selected to obtain a list of songs helpful in creating a romantic atmosphere.

Upon selection of an option appearing in such a list by the user, the remote server (RS) 18 searches its memory to locate song titles corresponding to the selection and transmits the list of song titles for display on the interactive multimedia system (IMS) 18.

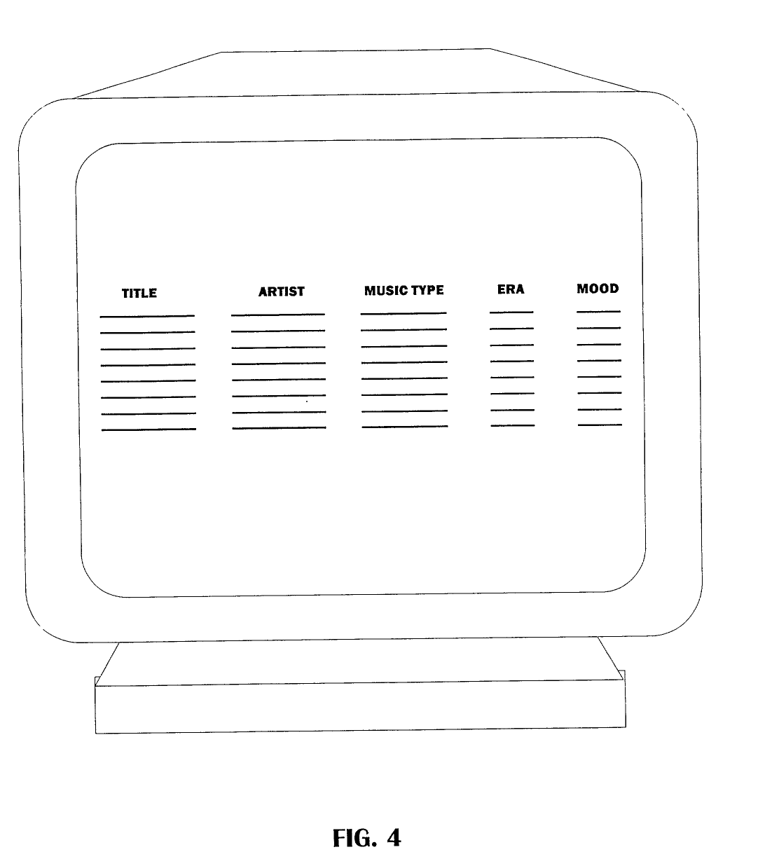

If the user selects the option “5. Complete List of all Available Songs”, the remote server (RS) 18 downloads for display on the interactive multimedia system (IMS) 12 a file containing a list of available songs that are stored on the remote server (RS) 12 arranged in a desired manner such as by type of music, artist name, music type, era and mood as shown in FIG. 4, so that it provides the user with the ability to quickly view and identify songs of interest. Additional descriptive material may also be included.

Songs selected by the user in the foregoing manner are transmitted by the remote multimedia server (RS) 12 and received by the interactive multimedia system (IMS) 12 using conventional communication means such as the known MP3 method for transmitting music over the Internet.

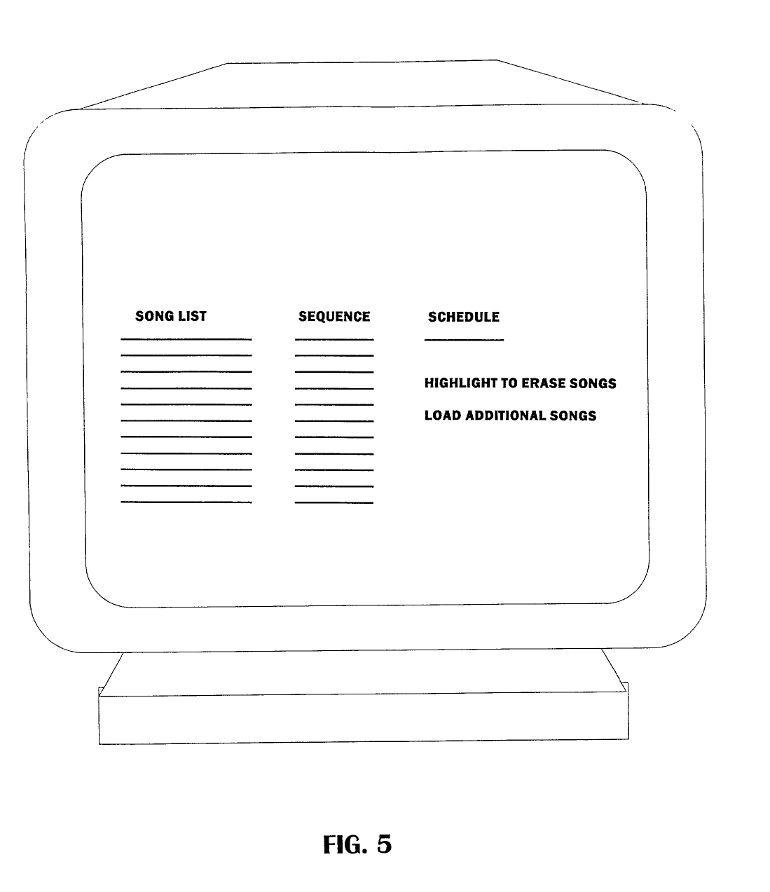

Referring to FIG. 5, the interactive multimedia system (IMS) 12 has a menu-driven user interface for enabling the user to control the sequence and schedule of songs to be played. As shown, the menu 26 contains in a list of songs stored in the memory of the interactive multimedia system (IMS) 12 along with a column permitting the user to control the sequence in which the songs are to be played by entering a number in the column. In addition, the user may enter a time schedule during which the songs are to be played. A control is provided to allow the user to erase a given song from memory, and a link to the remote server (RS) 18 is provided to permit the user to download additional songs.

The inventive system may further include means for providing enhanced music. For example, in addition to audio information, program source material for other information such as video may be provided to the interactive multimedia system (IMS) 12 from the remote server (RS) 18. The multimedia information can be sent down a network and may include stills, full motion video, lyrics, score and may be synchronized with the audio file for display on one or more monitors.

The system of the present invention may be implemented over a network such as the Internet. In this regard, the system of FIG. 1 would comprise a computer network based on the client-server model. Such a network comprises one or more “servers” (corresponding to the remote multimedia server 18) which are accessible by “clients” (corresponding to the interactive multimedia system 12), and which typically comprise personal computers, which, in the case of the Internet, is provided through a private Internet access provider or an on-line service provider (such as America On-Line, Prodigy, CompuServe, the Microsoft Network, and the like). Each of the clients may run a “Web browser”, which is a known software tool used to access the World Wide Web via a connection obtained through an access provider. The remote server 18 allows access to various network resources. In the Internet, for example, a Web server allows access to so-called “Web sites” which comprise resources in various different formats. A location of a resource on the server 18 is identified by a so-called Uniform Resource Locator, or URL. In this embodiment, the provider of the music distribution service would maintain a Web site from which registered users would obtain above-described menus and selected songs.

The “World Wide Web” (“Web”) is a collection of servers on the Internet that utilize the Hypertext Transfer Protocol (HTTP). HTTP is a known application protocol that provides users access to resources (which can be information in different formats such as text, graphics, images, sound, video, Hypertext Markup Language (“HTML”), etc.) as well as programs. HTML is a standard page description language which provides basic document formatting and allows the developer to specify “links” to other servers and files. Links are specified via a Uniform Resource Locator or “URL”. Upon specification of a link (or option) in one of the menus described above, the interactive multimedia system (IMS) 12 would make a TCP/IP request to the remote server (RS) 18 and receive a follow-up menu specified in that URL. For example, in response to the selection of “Music Type” in the FIG. 2 menu, the FIG. 3 menu 26 comprising a Web page formatted according to HTML would be downloaded and displayed on the IMS 12 in return. A typical Web page is an HTML document with text, links that a user may activate (e.g. “click on”), as well as embedded URLs pointing to resources (such as images, video or sound) that the interactive multimedia system (IMS) 12 (client computer) must fetch to fully render the Web Page in a browser. Thus, song titles appearing on downloaded lists would be linked to songs stored in the memory of the remote server (RS) 18.

Accordingly, in an Internet based implementation of the inventive method and system, the above-described menus and lists would be HTML documents served by the remote multimedia server (RS) 18 and identified by unique URLs accessed by a user upon activation of a “link” contained in another menu formatted according to the HTML standard.

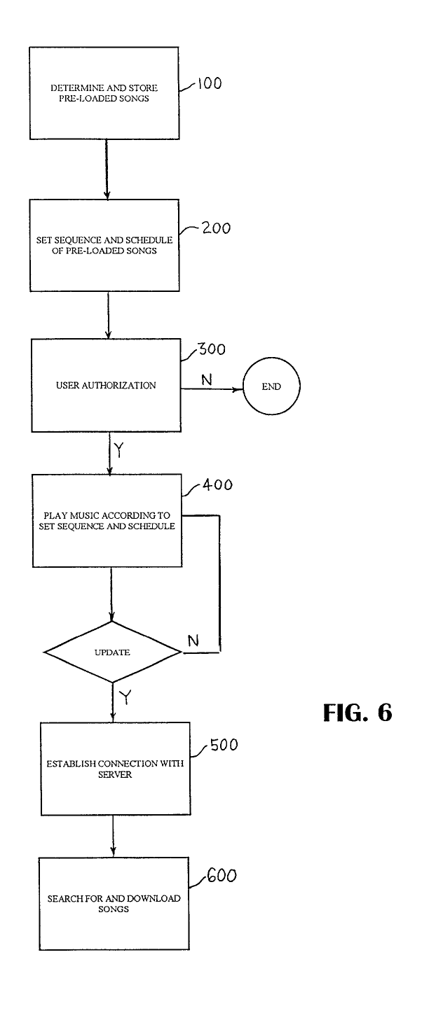

FIG. 6 is a flowchart illustrating a typical method for implementing the inventive music distribution system.

In a preferred embodiment, the interactive multimedia system (IMS) 12 is provided to a user with a pre-loaded library of songs that are pre-selected by the user based on discussion with the music service provider and/or selection from a list of available songs (step 100). Alternately, the pre-selected songs may be selected by the service provider based on a desired mood or atmosphere expressed by the user. For instance, a selection of easy listening music would likely be made for a restaurant owner desiring peaceful background music, while rock music would normally be selected for a bar and dance music would be selected for a nightclub. In addition, the sequence and schedule at which the songs are to be played is preferably pre-set based on the user's particular requirements (step 200). These options may be varied by means of the menu shown in FIG. 5.

When the user wishes to play music, the interactive multimedia system (IMS) 12 first verifies whether the user has paid any necessary license fees (step 300). If so, the system is enabled to play songs and to obtain additional songs from the remote server (RS) 18 (step 400).

The song content of the interactive multimedia system (IMS) 12 may be updated in any one of several ways. First, the user may erase one or more of the songs by reviewing a list of stored songs and deleting songs in a similar manner to deleting files on a conventional computer. In order to order new songs, the user may establish a connection with the remote multimedia server (RS) 18 via the link provided in the menu shown in FIG. 5 (step 500).

Using the menu-driven user interface described above, the user may search the interactive song library for available songs of interest that are stored on the remote server 18 (step 600). Selection of a song by a user causes the remote server 18 to transmit the selected song to the interactive multimedia system (IMS) 12. Alternatively, the service provider can automatically update the song content of the interactive multimedia system (IMS) 12 on a periodic basis to maintain the content up-to-date. Time periods at which updating is performed are determined based on the available bandwidth. For instance, using a conventional dial-up Internet connection, a relatively extensive amount of time is needed to download a large number of MP3-formatted songs. Thus, the update process would be performed on a more frequent basis than a system having a high-speed connection between the interactive multimedia system (IMS) 12 and the remote server (RS) 18. As an alternative, updating can be performed by sending or delivering CDs containing new songs to individual users.

From the foregoing description, it can be seen that the present invention comprises a novel method and apparatus for the distribution and playing of songs. It will be appreciated by those skilled in the art that obvious changes can be made to the embodiment and methods described in the foregoing description without departing from the broad inventive concept thereof. It is understood, therefore, that this invention is not limited to the particular embodiment disclosed, but is intended to cover all obvious modifications thereof which are within the scope and the spirit of the invention as defined by the appended claims.

I claim:

1. An apparatus for receiving, storing and playing music, comprising:
one or more interactive multimedia systems comprising playing means for playing a first plurality of songs in a desired sequence and schedule, a memory for storing the plurality of songs, and a processor for controlling the playing means to play the selected songs in the desired sequence and schedule and controlling the selection and downloading of songs from a server; and
a server having a memory for storing a second plurality of songs larger than the first plurality, means for communicating with the one or more interactive multimedia systems for receiving from the interactive multimedia systems a list of selected songs and transmitting the requested songs to the interactive multimedia systems, and a processor for maintaining records of songs downloaded to the interactive multimedia systems.

2. An apparatus according to claim 1; wherein the memory of the server contains a searchable database containing descriptive data corresponding to each of the songs; and the server generates a user interface on the interactive multimedia system comprising one or more menus which allow a user to search the database to locate songs to be downloaded from the server for storage and playing on the interactive multimedia system based on the descriptive data.

3. An apparatus according to claim 2; wherein the one or more menus comprise a first menu that allows a user to search the database by categorizing the songs stored in the server according to descriptive criteria.

4. An apparatus according to claim 3; wherein the descriptive criteria comprises at least one of song title, artist name, music type, musical era, mood, tone and beat.

5. An apparatus according to claim 2; wherein the interactive multimedia system generates a second menu that allows the user to view a list of songs stored on the interactive multimedia system and to add or remove stored songs and control the sequence and schedule for playing the songs.

6. A method for receiving, storing and playing music, comprising the steps of:
creating a play list of songs;
transmitting from a server to an interactive multimedia system a list of one or more selected songs;
receiving from the server and playing on the interactive multimedia system the received songs in a pre-defined sequence and schedule; and
updating the play list to add or remove songs.
